(19) United States
(12) Patent Application Publication
(10) Pub. No.: US 2009/0040372 A1
(43) Pub. Date: Feb. 12, 2009

(54) DIGITAL BROADCASTING TRANSMITTING/RECEIVING APPARATUS AND METHOD

(75) Inventors: Byungjun Bae, Daejeon-city (KR); Sung-Hoon Kim, Daejeon-city (KR); Suk Hee Cho, Daejeon-city (KR); Kug Jin Yun, Daejeon-city (KR); Yong Tae Lee, Daejeon-city (KR); Heung Mook Kim, Daejeon-city (KR); Jong Soo Lim, Seoul (KR); Soo In Lee, Daejeon-city (KR)

Correspondence Address: CANTOR COLBURN, LLP, 20 Church Street, 22nd Floor, Hartford, CT, 06103, US

(73) Assignee: Electronics and Telecommunications Research Institute, Daejeon-city (KR)

(21) Appl. No.: 12/112,469

(22) Filed: Apr. 30, 2008

(30) Foreign Application Priority Data
Aug. 7, 2007 (KR) 10-2007-0079187

(51) Int. Cl. H04N 7/12; H04N 7/173

(52) U.S. Cl. 348/436.1; 725/136; 348/E07.045

(57) ABSTRACT

Provided are a digital broadcasting transmitting/receiving apparatus and method. By converting content of a main-program to a stream, converting content of a sub-program forming a single digital broadcasting service through synchronization with the main-program by being subordinated to the main-program to a stream, generating program configuration information containing stream conversion information of the main-program and stream conversion information of the sub-program, multiplexing the converted main-program stream and the generated program configuration information and real-time transmitting the multiplexed signal, and transmitting the converted sub-program stream in non-real-time, various and new premium services with compatibility with existing digital broadcasting services can be provided to users.

### CROSS-REFERENCE TO RELATED PATENT APPLICATION

This application claims the benefit of Korean Patent Application No. 10-2007-0079187, filed on Aug. 7, 2007, in the Korean Intellectual Property Office, the disclosure of which is incorporated herein in its entirety by reference.

### BACKGROUND OF THE INVENTION

1. Field of the Invention

The present invention relates to a digital broadcasting transmitting/receiving apparatus and method, and more particularly, to a digital broadcasting transmitting/receiving apparatus and method for providing various and new premium services to users with compatibility with existing digital broadcasting services by non-real-time transmitting a sub-program synchronized to a main-program transmitted in real-time.

The present invention is derived from a research project supported by the Information Technology (IT) Research & Development (R&D) program of the Ministry of Information and Communication (MIC) and the Institute for Information Technology Advancement (IITA) [2006-S-016-02, terrestrial DTV distributed transmission technology development].

2. Description of the Related Art

In digital broadcasting, requirements of premium services, such as a 3-dimensional (3D) stereo broadcasting service and a multi-program service, differentiated from existing broadcasting services are increasing. Nonetheless, it is difficult to apply these premium services to the real life because the existing broadcasting services occupy a considerable transmission rate in a limited bandwidth. That is, when the premium services are provided, high definition (HD) broadcasting services having high image quality or standard definition (SD) broadcasting services of a plurality of channels through which various broadcasting programs can be used cannot be provided.

An embodiment illustrated in FIG. 1 of Korean Patent application No. 1999-0060127 discloses a structure of a digital broadcasting system transmitting conventional 2D images and additional information for 3D broadcasting at the same time in order to provide a 3D stereo broadcasting service.

The disclosed digital broadcasting system has a structure for simultaneously compressing, multiplexing, and transmitting two signals. In this embodiment an audio signal is also compressed and multiplexed, and MPEG-2 program specific information (PSI) having digital broadcasting configuration information is also multiplexed. In this case, there are several problems. First, it is difficult for conventional technology to be actually applied to a digital broadcasting system since the conventional technology vaguely describes most technical parts except providing of a 3D broadcasting service. That is, in order to provide a new digital broadcasting service, definition of the new digital broadcasting service must be newly established in program and system information protocol (PSIP).service information (SI)/PSI indicating broadcasting program configuration information or service detail information. Second, since this new service providing method occupies a constant transmission rate in an existing limited bandwidth, the method exerts a bad influence to other existing digital services. Due to these problems, a method having the least influence to existing broadcasting services and applying new services to an existing digital broadcasting system is required.

### SUMMARY OF THE INVENTION

The present invention provides a digital broadcasting transmitting/receiving apparatus and method for providing various and new premium services to users with compatibility with existing digital broadcasting services by non-real-time transmitting a sub-program synchronized to a main-program transmitted in real-time when a digital broadcasting service is provided.

According to an aspect of the present invention, there is provided a digital broadcasting transmitting apparatus comprising: a main-program stream converter converting content of a main-program to a stream; a sub-program stream converter converting content of a sub-program forming a single digital broadcasting service through synchronization with the main-program by being subordinated to the main-program to a stream; a program configuration information generator generating program configuration information containing stream conversion information of the main-program and stream conversion information of the sub-program; a sub-transmitter transmitting the converted sub-program stream in non-real-time; and a main-transmitter multiplexing the converted main-program stream and the generated program configuration information and real-time transmitting the multiplexed signal.

According to another aspect of the present invention, there is provided a digital broadcasting receiving apparatus comprising: a sub-receiver forming a single digital broadcasting service through synchronization with a main-program by being subordinated to the main-program, and receiving a sub-program stream in non-real-time; a sub-program storage unit storing the received sub-program stream; a main-receiver real-time receiving a signal in which program configuration information containing stream conversion information of the main-program and stream conversion information of a sub-program and a main-program stream are multiplexed; a demultiplexer extracting the program configuration information and the main-program stream by demultiplexing the received signal; a main-program restoration unit restoring the main-program stream to content of the main-program by using the extracted program configuration information; a sub-program restoration unit extracting the sub-program stream subordinated to the main-program from the sub-program storage unit and restoring the extracted sub-program stream to content of the sub-program; and a synchronizer generating a single digital broadcasting service by synchronizing the main-program content and the sub-program content.

According to an another aspect of the present invention, there is provided a digital broadcasting transmitting method comprising: converting content of a main-program to a stream; converting content of a sub-program forming a single digital broadcasting service through synchronization with the main-program by being subordinated to the main-program to a stream; generating program configuration information containing stream conversion information of the main-program and stream conversion information of the sub-program; transmitting the converted sub-program stream in non-real-time; and multiplexing the converted main-program stream and the generated program configuration information and real-time transmitting the multiplexed signal.

According to another aspect of the present invention, there is provided a digital broadcasting receiving method comprising: non-real-time receiving a sub-program stream forming a single digital broadcasting service through synchronization with a main-program by being subordinated to the main-program; real-time receiving a signal in which program configuration information containing stream conversion information of the main-program and stream conversion information of a sub-program and a main-program stream are multiplexed; extracting the program configuration information and the main-program stream by demultiplexing the received signal; restoring the main-program stream to content of the main-program by using the extracted program configuration information; restoring the sub-program stream subordinated to the main-program to content of the sub-program by using the program configuration information; and generating a single digital broadcasting service by synchronizing the main-program content and the sub-program content.

According to another aspect of the present invention, there is provided a computer readable recording medium storing a computer readable program for executing the digital broadcasting transmitting/receiving methods.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic block diagram of a digital broadcasting transmitting apparatus according to an embodiment of the present invention;

FIG. 2 is a flowchart illustrating a digital broadcasting transmitting method according to an embodiment of the present invention;

FIG. 3 is a schematic block diagram of a digital broadcasting transmitting system providing a new premium service, according to an embodiment of the present invention;

FIG. 4 is a schematic block diagram of a digital broadcasting receiving apparatus according to an embodiment of the present invention;

FIG. 5 is a flowchart illustrating a digital broadcasting receiving method performed by a digital broadcasting receiving apparatus, according to an embodiment of the present invention;

FIG. 6 is a schematic block diagram of a digital broadcasting receiving system providing a new premium service, according to an embodiment of the present invention;

FIG. 7 illustrates a table showing a configuration of a program map table (PMT) section in which descriptors of signaling information of a main-program and a sub-program, according to an embodiment of the present invention;

FIG. 8 illustrates a table showing descriptors of a PMT section in which streams for new premium services are defined, according to an embodiment of the present invention;

FIG. 9 illustrates a service location descriptor in which values of a new premium service are defined, according to an embodiment of the present invention; and

FIG. 10 illustrates an example of a stream_type configuration illustrated in FIG. 9, according to an embodiment of the present invention.

### DETAILED DESCRIPTION OF THE INVENTION

The present invention will be described in detail by explaining embodiments of the invention with reference to the attached drawings. Like reference numerals in the drawings denote like elements.

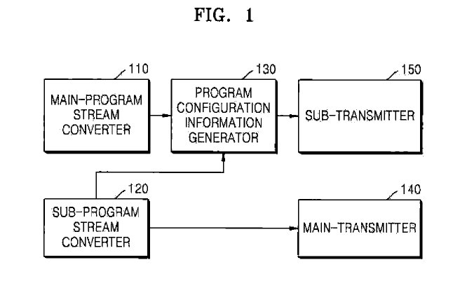

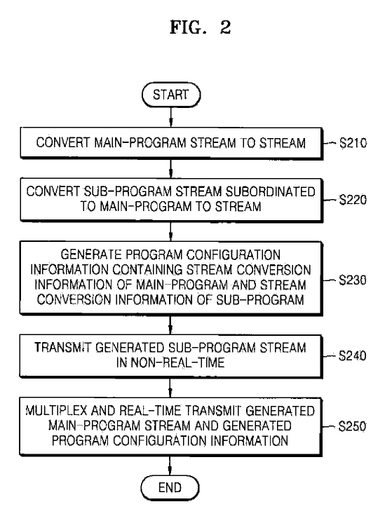

FIG. 1 is a schematic block diagram of a digital broadcasting transmitting apparatus according to an embodiment of the present invention, and FIG. 2 is a flowchart illustrating a digital broadcasting transmitting method performed by the digital broadcasting transmitting apparatus illustrated in FIG. 1.

Referring to FIGS. 1 and 2, the digital broadcasting transmitting apparatus according to the current embodiment includes a main-program stream converter 110, a sub-program stream converter 120, a program configuration information generator 130, a main-transmitter 140, and a sub-transmitter 150.

In operation S210, the main-program stream converter 110 converts content of a main-program, which is real-time provided, to a stream.

In operation S220, the sub-program stream converter 120 converts content of a sub-program, which is non-real-time provided, is subordinated to the main-program, and forms a single digital broadcasting service through synchronization with the main-program, to a stream.

In operation S230, the program configuration information generator 130 generates program configuration information containing stream conversion information of the main-program and stream conversion information of the sub-program subordinated to the main-program.

The program configuration information is implemented in the form of either program and system information protocol (PSIP) and program specific information (PSI) or system information (SI) and PSI and includes descriptor defining a sub-program stream.

PSIP/SI and PSI form broadcasting protocol information representing configuration information and service information of a broadcasting program.

Terrestrial digital broadcasting in Korea adopts an advanced television systems committee (ATSC) method that is an American method, and in the ATSC method, configuration information and service information of a broadcasting program are included in terrestrial PSIP and PSI.

Satellite digital broadcasting in Korea adopts a digital video broadcasting (DVB) method that is a European method, in the DVB method, configuration information and service information of a broadcasting program are included in SI and PSI.

Cable digital broadcasting in Korea adopts an OpenCable method, and in the OpenCable method, configuration information and service information of a broadcasting program are included in cable PSIP and PSI.

These three methods are based on MPEG-2 system specification, and since program configuration information is represented using PSI in the MPEG-2 system specification, all of the three methods represent a program configuration using PSI. However, in the necessity of broadcasting protocol information, PSI is optional and PSIP is mandatory in ATSC, PSI and SI are mandatory in DVB, and PSI is mandatory and PSIP is optional in Open Cable.

Thus, in order for the three methods to be able to be applied to any digital broadcasting system, program configuration information must be defined in PSIP and PSI.

PSI is formed with a program association table (PAT), a program map table (PMT), and a conditional access table (CAT), wherein configuration information of a broadcasting program and stream type information must be defined in the PMT.

PSIP, in particular in a case of an ATSC or OpenCable system, is formed with a master guide table (MGT), a system time table (STT), and a virtual channel table (VCT), wherein descriptors of configuration information of a broadcasting program and stream type information must be defined in the VCT. In particular, a descriptor for defining a sub-program stream from among the descriptors in VCT must be defined as a service location descriptor.

In operation S240, the sub-transmitter 140 non-real-time transmits the sub-program stream converted by the sub-program stream converter 120. It can be implemented that the sub-transmitter 140 transmits the sub-program stream via a transmission network different from that of the main-transmitter 150.

In operation S250, the main-transmitter 150 multiplexes the main-program stream converted by the main-program stream converter 110 and the program configuration information generated by the program configuration information generator 130 and real-time transmits the multiplexed signal as a single stream. It can be implemented that the main-transmitter 150 multiplexes and transmits the main-program stream converted by the main-program stream converter 110, the program configuration information generated by the program configuration information generator 130, and a sub-program stream which is not subordinating to the main-program.

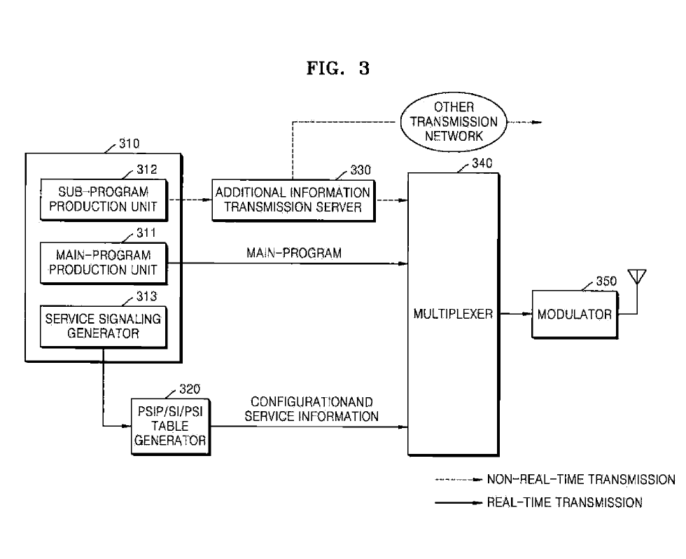

FIG. 3 is a schematic block diagram of a digital broadcasting transmitting system providing a new premium service by using the digital broadcasting transmitting apparatus illustrated in FIG. 1, according to an embodiment of the present invention. Thus even if omitted, the description regarding the digital broadcasting transmitting apparatus illustrated in FIG. 1 is applied to the digital broadcasting transmitting system according to the current embodiment.

Referring to FIG. 3, the digital broadcasting transmitting system according to the current embodiment includes a premium service production unit 310, a PSIP/SI/PSI table generator 320, an additional information transmission server 330, a multiplexer 340, and a modulator 350.

The premium service production unit 310 includes a main-program production unit 311, a sub-program production unit 312, and a service signaling generator 313.

The main-program production unit 311 produces a stream of a main-program by encoding broadcasting content in a conventional method.

The sub-program production unit 312 produces a sub-program for providing a new premium service, such as a 3D stereo broadcasting service or a multi program service. That is, the sub-program production unit 312 encodes video and audio signals subordinated to the sub-program and transmits the encoded signals to the additional information transmission server 330.

The additional information transmission server 330 transmits the sub-program via a broadcasting network by allocating a little transmission rate in non-real-time or transmits the sub-program via another broadcasting network, such as Internet, so that the sub-program is previously stored in a storage medium of a digital broadcasting receiving system.

The service signaling generator 313 generates information on a new premium service. The PSIP/SI/PSI table generator 320 generates a new PSIP/SI/PSI table to meet a digital broadcasting specification.

The PSIP/SI/PSI table generator 320 generates a new PSIP/SI/PSI table containing the information generated by the service signaling generator 313 according to the digital broadcasting specification.

The multiplexer 340 multiplexes the main-program stream generated by the main-program production unit 311, the sub-program stream generated by the sub-program production unit 312, and the PSIP/SI/PSI table generated by the PSIP/SI/PSI table generator 320 to a single stream and transmits the multiplexed stream via the modulator 350.

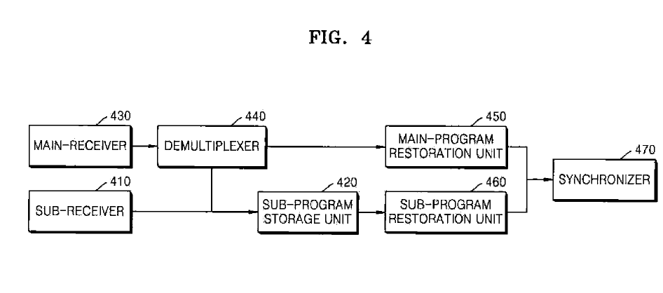

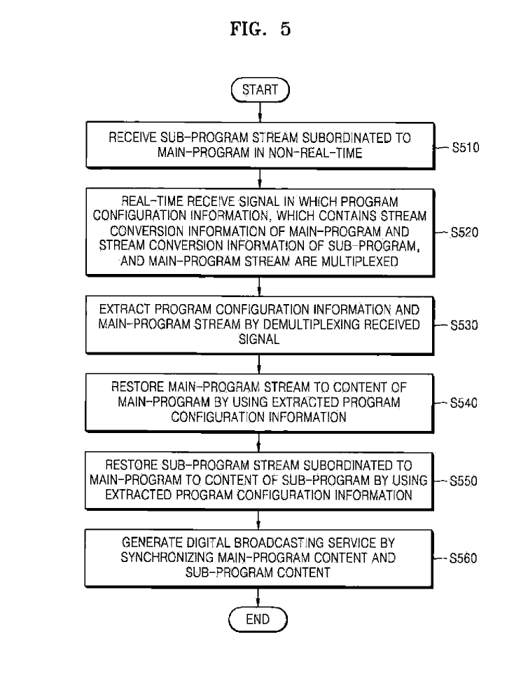

FIG. 4 is a schematic block diagram of a digital broadcasting receiving apparatus according to an embodiment of the present invention, and FIG. 5 is a flowchart illustrating a digital broadcasting receiving method performed by the digital broadcasting receiving apparatus illustrated in FIG. 4.

Referring to FIGS. 4 and 5, the digital broadcasting receiving apparatus according to the current embodiment includes a sub-receiver 410, a sub-program storage unit 420, a main-receiver 430, a demultiplexer 440, a main-program restoration unit 450, a sub-program restoration unit 460, and a synchronizer 470.

In operation S510, the sub-receiver 410 non-real-time receives a stream of a sub-program forming a single digital broadcasting service through synchronization with a main-program by being subordinated to the main-program that is real-time provided. It can be implemented that the sub-receiver 410 receives the sub-program stream via a transmission network different from that of the main-receiver 430.

The sub-program storage unit 420 stores the sub-program stream received by the sub-receiver 410.

In operation S520, the main-receiver 430 real-time receives a signal in which program configuration information, which contains stream conversion information of the main-program and stream conversion information of the sub-program, and a main-program stream are multiplexed. The program configuration information is implemented in the form of PSIP and PSI or SI and PSI and includes a descriptor defining the sub-program stream.

In operation S530, the demultiplexer 440 extracts the program configuration information and the main-program stream by demultiplexing the signal received by the main-receiver 430.

When the main-receiver 430 receives a signal in which the main-program stream, the program configuration information, and a stream of a sub-program which is not subordinated to the main-program are multiplexed, the demultiplexer 440 extracts the sub-program stream by demultiplexing the signal received by the main-receiver 430, and the sub-program storage unit 420 stores the extracted sub-program stream.

In operation S540, the main-program restoration unit 450 restores the main-program stream extracted by the demultiplexer 440 to content of the main-program by using the program configuration information extracted by the demultiplexer 440.

In operation S550, the sub-program restoration unit 460 extracts the sub-program stream subordinated to the main-program from the sub-program storage unit 420 by using the program configuration information extracted by the demultiplexer 440 and restores the extracted sub-program stream to content of the sub-program.

In operation S560, the synchronizer 470 generates a single digital broadcasting service by synchronizing the main-program content restored by the main-program restoration unit 450 and the sub-program content restored by the sub-program restoration unit 460. The synchronization is performed by referring to time information in each of the main-program content and the sub-program content.

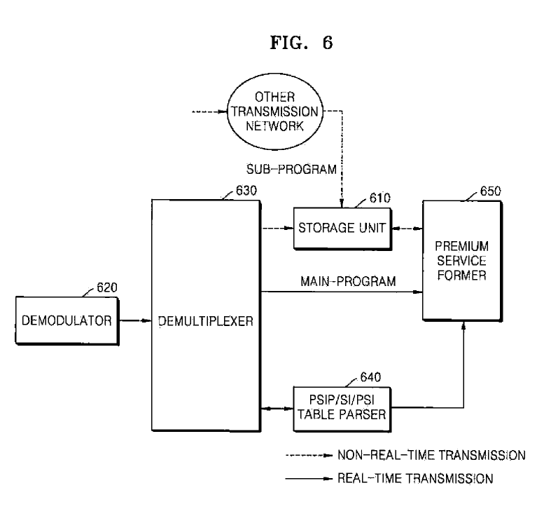

FIG. 6 is a schematic block diagram of a digital broadcasting receiving system providing a new premium service by using the digital broadcasting receiving apparatus illustrated in FIG. 4, according to an embodiment of the present invention. Thus even if omitted, the description regarding the digital broadcasting receiving apparatus illustrated in FIG. 4 is applied to the digital broadcasting receiving system according to the current embodiment.

A storage unit 610 previously stores a sub-program transmitted via a transmission network different from a broadcasting network and waits until signaling information of a main-program to which the stored sub-program is subordinated arrives.

A demultiplexer 630 demultiplexes a main-program and a PSIP/SI/PSI table from a stream received by a demodulator 620.

A PSIP/SI/PSI table parser 640 parses the PSIP/SI/PSI table extracted by the demultiplexer 630 and provides signaling information of a sub-program to a premium service former 650.

The premium service former 650 decodes video and audio streams of the main-program and decodes video and audio streams of the sub-program stored in a storage medium, based on parsing information provided by the PSIP/SI/PSI table parser 640. Thereafter, the premium service former 650 forms a new premium service by synchronizing the two programs with reference to time information in the two programs.

To enable such a premium service, signaling of a new service must be defined and applied to an existing digital broadcasting system as described above. The signaling must be newly defined in the PSIP/SI/PSI table providing configuration and service information of a broadcasting program in the digital broadcasting specification. Thus, the signaling is defined in a PSIP table and a PSI table so that the new service can be applied to various digital broadcasting methods. The signaling must be defined in the form of descriptor in the PSIP and PSI tables, wherein signaling of a main-program must include information that the main-program has a sub-program and signaling of a sub-program must include information that the sub-program is subordinated to a main-program.

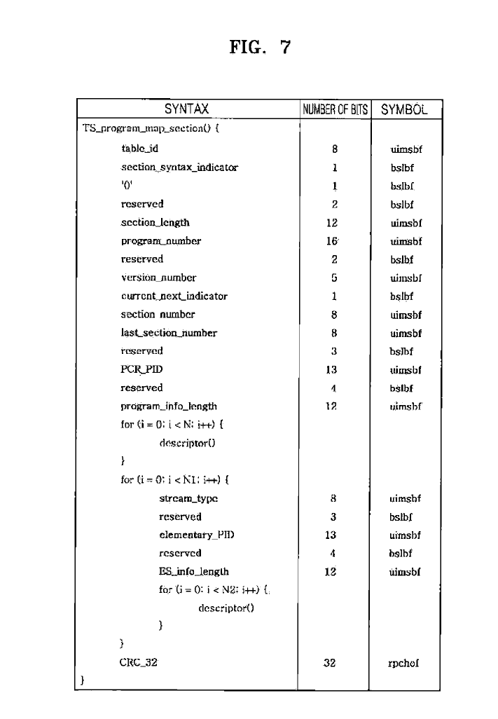

FIG. 7 illustrates a table showing a configuration of a PMT section in which descriptors of signaling information of a main-program and a sub-program, according to an embodiment of the present invention.

In the PMT section illustrated in FIG. 7, a descriptor for defining video and audio streams of a program is defined in a for syntax containing stream_type, reserved, and elementary_PID. Thus, a descriptor for defining a stream of a new premium service must be defined in the for syntax, and since streams forming new premium services are different from a conventional stream, the streams must be identified by being newly defined in stream_type in the PMT table. Except values defined in the MPEG-2 system specification, these new definitions can be defined in a reserved value or a value allocated as user private according to characteristics of a service.

When stream_type is allocated as user private, elementary_PID can be set and used by a user and defines a value of a sub-program stream added for a new premium service.

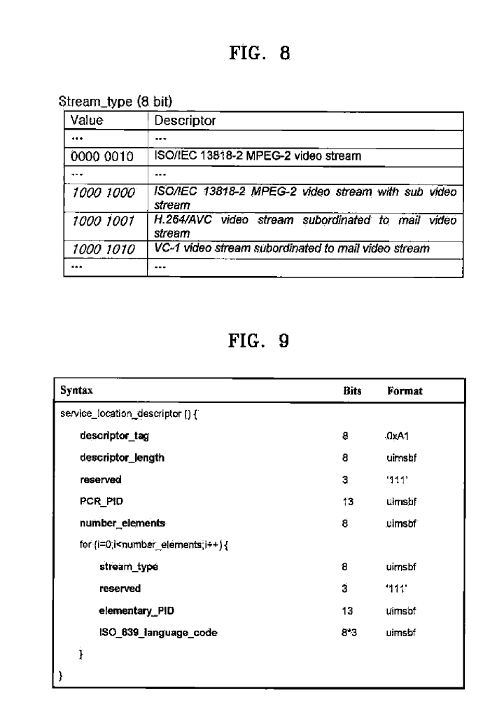

FIG. 8 illustrates a table showing descriptors of the PMT section illustrated in FIG. 7, in which streams for new premium services are defined, according to an embodiment of the present invention.

As described in FIG. 8, an ISO/IEC 13818-2 MPEG-2 video stream having a sub-video stream as a sub-program can be newly defined as 1000 1000, an H.264/AVC video stream is a sub-video stream subordinated to a main-video stream as 1000 1001, and a VC-1 video stream is a sub-video stream subordinated to a main-video stream as 1000 1010. Alternatively, without separately defining the main-video stream by considering backward compatibility, the stream (ISO/IEC 13818-2 MPEG-2 video stream: 0000 0010) defined in the existing specification may be used as it is, and only video streams subordinated to a main-video stream may be used the same as the above. In this case, when a sub-program is transmitted, the sub-program must have information on a main-program.

FIG. 9 illustrates a service location descriptor in which values of a new premium service are defined, according to an embodiment of the present invention.

In the syntax of the service location descriptor illustrated in FIG. 9, a descriptor of information on a new premium service according to the current embodiment is defined in a for syntax containing stream_type, reserved, and elementary_PID.

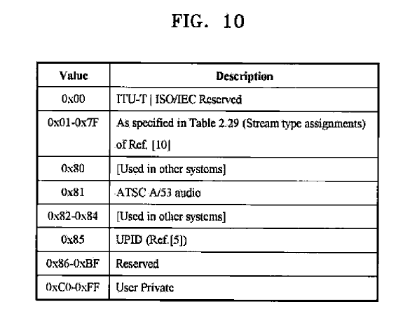

FIG. 10 illustrates an example of the stream_type configuration illustrated in FIG. 9, according to an embodiment of the present invention. Stream_type illustrated in FIG. 9 is matched the same as that defined in the PMT section illustrated in FIG. 7 by referring to the definition illustrated in FIG. 10. In this case, a usable value is one of a reserved value or a value defined as user private.

In addition, the descriptor is the same as described in FIG. 8, wherein a value of the descriptor must be the same in PSI and PSIP.

The embodiments of the present invention can be written as computer programs and can be implemented in general-use digital computers that execute the programs using a computer readable recording medium. Examples of the computer readable recording medium include magnetic storage media (e.g., ROM, floppy disks, hard disks, etc.), optical recording media (e.g., CD-ROMs, or DVDs), and storage media such as carrier waves (e.g., transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

As described above, according to the present invention, new premium services using a real-time main-program and a non-real-time sub-program can be provided to users with compatibility with existing digital broadcasting services. In addition, by concretely defining descriptor of a new premium service within digital broadcasting specification, the new premium service can be easily commercialized.

While the present invention has been particularly shown and described with reference to exemplary embodiments thereof, it will be understood by one of ordinary skill in the art that various changes in form and details may be made therein without departing from the spirit and scope of the present invention as defined by the following claims.

What is claimed is:

1. A digital broadcasting transmitting method comprising:
converting content of a main-program to a stream;
converting content of a sub-program forming a digital broadcasting service through synchronization with the main-program to a stream;
generating program configuration information containing stream conversion information of the main-program and stream conversion information of the sub-program;
transmitting the converted sub-program stream in non-real-time; and
multiplexing the converted main-program stream and the generated program configuration information and real-time transmitting the multiplexed signal.

2. The digital broadcasting transmitting method of claim 1, wherein the transmitting of the multiplexed signal comprises multiplexing and transmitting the converted main-program stream, the generated program configuration information, and a sub-program stream not subordinated to the main-program.

3. The digital broadcasting transmitting method of claim 1, wherein a transmission network of the subprogram is different from a transmission network of the main-program.

4. The digital broadcasting transmitting method of claim 1, wherein the program configuration information comprises a descriptor defining the sub-program stream.

5. The digital broadcasting transmitting method of claim 4, wherein the descriptor of the sub-program stream comprises information on the main-program stream.

6. The digital broadcasting transmitting method of claim 1, wherein the program configuration information is implemented in a form of program and service information protocol (PSIP) and program specific information (PSI), or implemented in a form of system information (SI) and PSI.

7. The digital broadcasting transmitting method of claim 6, wherein the PSI comprises a program map table (PMT) section containing a descriptor defining the sub-program stream.

8. The digital broadcasting transmitting method of claim 6, wherein the PSIP comprises a virtual channel table (VCT) section containing a service location descriptor defining the sub-program stream.

9. A digital broadcasting receiving apparatus comprising:
a sub-receiver forming a single digital broadcasting service through synchronization with a main-program, and receiving a sub-program stream in non-real-time;
a sub-program storage unit storing the received sub-program stream;
a main-receiver real-time receiving a signal in which program configuration information containing stream conversion information of the main-program and stream conversion information of a sub-program and a main-program stream are multiplexed;
a demultiplexer extracting the program configuration information and the main-program stream by demultiplexing the received signal;
a main-program restoration unit restoring the main-program stream to content of the main-program by using the extracted program configuration information;
a sub-program restoration unit extracting the sub-program stream subordinated to the main-program from the sub-program storage unit and restoring the extracted sub-program stream to content of the sub-program; and
a synchronizer generating a digital broadcasting service by synchronizing the contents of the main-program and the sub-program.

10. The digital broadcasting receiving apparatus of claim 9, wherein the main-receiver receives a signal in which the main-program stream, the program configuration information, and a stream of a sub-program not subordinated to the main-program,
the demultiplexer extracts the sub-program stream by demultiplexing the signal received by the main-receiver, and
the sub-program storage unit stores the extracted sub-program stream.

11. The digital broadcasting receiving apparatus of claim 9, wherein the sub-receiver receives the sub-program stream via a transmission network different from that of the main-receiver.

12. The digital broadcasting receiving apparatus of claim 9, wherein the program configuration information comprises a descriptor defining the sub-program stream.

13. The digital broadcasting receiving apparatus of claim 12, wherein the descriptor of the sub-program stream comprises information on the main-program stream.

14. The digital broadcasting receiving apparatus of claim 9, wherein the program configuration information is implemented in a form of program and service information protocol (PSIP) and program specific information (PSI), or implemented in a form of system information (SI) and PSI.

15. The digital broadcasting receiving apparatus of claim 14, wherein the PSI comprises a program map table (PMT) section containing a descriptor defining the sub-program stream.

16. The digital broadcasting receiving apparatus of claim 14, wherein the PSIP comprises a virtual channel table (VCT) section containing a service location descriptor defining the sub-program stream.

17. A digital broadcasting receiving method comprising:
non-real-time receiving a sub-program stream forming a single digital broadcasting service through synchronization with a main-program;
real-time receiving a signal in which program configuration information containing stream conversion information of the main-program and stream conversion information of a sub-program and a main-program stream are multiplexed;
extracting the program configuration information and the main-program stream by demultiplexing the received signal;
restoring the main-program stream to content of the main-program by using the extracted program configuration information;
restoring the sub-program stream subordinated to the main-program to content of the sub-program by using the program configuration information; and
generating a digital broadcasting service by synchronizing the contents of the main-program and the sub-program.

18. The digital broadcasting receiving method of claim 17, further comprising, when a signal in which the main-program stream, the program configuration information, and a stream of a sub-program independent on the main-program is received in the receiving of the main-program stream, extracting and storing the sub-program stream by demultiplexing the signal received by the main-receiver.

19. The digital broadcasting receiving method of claim 17, wherein a transmission network of the sub-program is different from a transmission network of the main-program.

20. The digital broadcasting receiving method of claim 17, wherein the program configuration information comprises a descriptor defining the sub-program stream.

21. The digital broadcasting receiving method of claim 20, wherein the descriptor of the sub-program stream comprises information on the main-program stream.

22. The digital broadcasting receiving method of claim 17, wherein the program configuration information is implemented in a form of program and service information protocol (PSIP) and program specific information (PSI), or implemented in a form of system information (SI) and PSI.

23. The digital broadcasting receiving method of claim 22, wherein the PSI comprises a program map table (PMT) section containing a descriptor defining the sub-program stream.

24. The digital broadcasting receiving method of claim 22, wherein the PSIP comprises a virtual channel table (VCT) section containing a service location descriptor defining the sub-program stream.
